(19) United States
(12) Patent Application Publication
(10) Pub. No.: US 2023/0121446 A1
(43) Pub. Date: Apr. 20, 2023

(54) Snap-Install Light Assembly and Method of Use

(71) Applicant: Susan C. Kelly, Alexandria, VA (US)

(72) Inventor: Susan C. Kelly, Alexandria, VA (US)

(21) Appl. No.: 17/272,341

(22) PCT Filed: Feb. 28, 2021
(86) PCT No.: PCT/US21/20146

§ 371 Date: Feb. 28, 2021

Related U.S. Application Data
(60) Provisional application No. 62/982,666, filed on Feb. 27, 2020.

(51) Int. Cl. F21V 21/03; F21V 23/06

(52) U.S. Cl. CPC F21V 21/03; F21V 23/06

(57) ABSTRACT

The assembly for a cartridge system with a hardwired electrical assembly comprising an adaptor as a separate unit in combination with a detachable quick-connect electrical cartridge, or in the form of two cartridges with male and female electrical connectors and snap-in attachments allowing for the connection of the two cartridges and the electrical connectors. The assembly may also have a retractable cord with a direct electrical connection such as a plug used to electrically connect the cartridge system to a fixture so as to allow the easy installation of a fixture in or on a structure. For example, a ceiling electrical box and mating cartridge may allow for a light fixture to be installed and mounted with no tools.

### PRIORITY CLAIM

The present application claims priority to Provisional Application No. 62/982,666, filed Feb. 27, 2020, titled Snap-Install Light Assembly and Method of Use.

### FIELD OF THE INVENTION

The present invention relates generally to an electrical fixture, and more particularly, to an installed electrical box having replaceable components for easy and efficient installation.

### BACKGROUND OF THE INVENTION

Traditional lighting and electrical connections are hard wired professionally. Techniques for installing electrical fixtures also involve processes requiring the skills of an electrician in hardwiring the fixture or outlet. A qualified electrician is typically required to hardwire the fixture because they have specialized knowledge and the proper tools needed to perform the tasks. Additionally, if an individual attempts to hardwire the fixture, the hardwire may be improperly connected or constructed leading to personal harm such as electrical shock, fire, hazardous electrical issue, or even death. Further, separate arrangements and installations may need to be installed if the fixture is a suspended fixture. Such mechanical and electrical adjustments for installation therefore may be technically burdensome, dangerous, time consuming, and costly.

In domestic lighting systems, rooms are traditionally lit by using a central ceiling light with possible fan combination installed on the ceiling. This makes it difficult for persons to access the fixtures to adjust them, change bulbs, clean, and perform other tasks. If an individual desires to perform any of these tasks, a ladder is typically needed, placing the individual in harm's way having to not only ascend the ladder to perform the task, which could potentially be dangerous, but then attempt to address any mechanical and/or electrical issue or situation with the light which could also cause serious harm or bodily injury, even death.

Prior devices and assemblies have attempted to provide removable aspects, but the issue of modifying any fixture or lighting apparatus has required disconnection from an electrical supply; or utilizing replacement bulbs in replacing a light bulb with another light bulb having the same size and features as specified for us in the particular lighting apparatus.

Accordingly, a need exists for a simple way to install an electrical fixture or electrical connection, including a light fixture, that does not require a certified electrician or specialized tools, and limits ascension up and/or descension down a ladder. The need also exists to further reduce the time in configuring electrical connections and lighting connections while minimizing cost. The embodiments disclosed herein address the needs in the art and further improve the health and safety of persons working and living in such settings having electrical connections and fixtures.

The following aforementioned problems and shortcomings of the prior art are addressed by following disclosure.

### SUMMARY OF THE INVENTION

In view of the foregoing disadvantages inherent in the known art, the present invention provides a novel device, system and method of use. The embodiments disclosed herein, which will be subsequently described in greater detail, provide an integrated electrical assembly comprising an electrical adaptor and a mating cartridge to allow a light fixture to be installed without any tools after the electrical box is professionally installed. The electrical assembly may replace currently existing electrical box(es) and be mounted with screws or other attachment mechanisms or may include an adaptor that allows use of current electrical boxes.

One embodiment of an electrical snap-install cartridge comprises an adaptor removably placed with an electrical box, the adaptor having pre-wired connectors attached to one or more pre-existing wires in the electrical box; and an interchangeable electrical unit having at least one electrical interconnection at a first end that extends to a second electrical connection at a second end, the interconnection of which connects to the adaptor; wherein the interchangeable interchangeable electrical unit comprises mated components that quick-connect to and from the adaptor. The electrical snap-install cartridge may further comprise a coverplate assembly which aligns to cover the adaptor. The electrical snap-install cartridge may further comprise a grommet that secures the electrical unit through the coverplate to the adaptor. The interchangeable electrical unit may be covered by a covering including a lamp shade, transparent or translucent glass, or three-dimensional design covering. The interchangeable electrical unit, the coverplate assembly, the grommet, or the covering are further adapted for easy assembly and dis-assembly in a snap-install configuration, alone or in combination. As such, a user can assemble and dis-assemble a snap-install configuration of an electrical unit, a coverplate, a grommet, or a designer covering or lampshade as single units or in combination. In one aspect, the electrical unit is a socket, a switch, an outlet, a receptacle, a plug, a speaker or any electrical component, in pendant or flush-mount or semi-flush mount configurations. The semi-flush mount is almost flush with the surface of a structure to which an electrical box is embedded. A flush mount is adjacent to the surface of a structure where an electrical box is interconnected.

Embodiments herein describe an electrical snap-install cartridge provides a quick-attach and quick-release from a structural electrical box to allow a user to interchange electrical fixtures without the use of tools. The electrical snap-install cartridge comprises an adaptor removably placed with an electrical box, the adaptor having pre-wired connectors attached to one or more pre-existing wires in the electrical box, a coverplate assembly which aligns to cover the adaptor, an electrical cable with an interconnection at a first end and extends to a pendant electrical unit at a second end, the interconnection of which connects to the adaptor, and a grommet that secures the electrical unit through the coverplate to the adaptor; wherein the coverplate assembly and the electrical cable are mated components that quick-connect to and from the adaptor. The electrical snap-install cartridge may include a semi-flush mount or pendant electrical unit as a socket, a switch, an outlet, a receptacle, a plug, a speaker or any electrical component. The electrical snap-install cartridge may have an electrical cable that is adjustable and capable of being fixed to accommodate the size and dimensions of the pendant electrical unit. As well, the coverplate and the electrical cable may be integrated and connected as an integral unit, such that the integral unit is reversibly or removably placed and replaceable with a second integral unit. The adaptor has capability to attach both the first and second integral units at the same time. In one aspect, one electrical integral unit attaches by way of a central plug-and-play while a second electrical integral unit attaches at an edge or periphery of an adaptor plate. As such the adaptor plate would house a plurality of interconnections that would allow placement of one or more fixtures with multiple snap-fit interconnects. This would also allow fixing of both a pendant electrical component and a semi-flush mounted electrical component at the same time. One or more integral units are interchangeable and replaceable with a second integral unit.

Embodiments herein include an electrical assembly comprising a housing having an adaptor to interconnect one or more pre-wired connectors with one or more pre-existing wires in an electrical box, the housing further comprising an engagement mechanism to mount to the electrical box, a coverplate assembly securing a surface that covers the pre-wired connectors, at least one wired component having a first end connected through the coverplate to the adaptor and a second end connected to an electrical component, and the electrical component comprising at least one of a socket, a switch, an outlet, a receptacle, speaker and a plug, wherein said wired component is interchangeable in a snap-fit configuration. The adaptor may comprise one or more interconnecting electrical connections to connect to the wired components, such that a plurality of wired components can mount to the adaptor as a pendant attachment or semi-flush attachment. For exemplary purposes, and not limitation, the interconnecting electrical connections are positioned at a central location on an adaptor plate or along a periphery of the adaptor plate. The electrical component can be interchangeable in a snap-fit configuration. One or more electrical interconnections at the second end of the wired component allow a user to modify the electrical component. In one aspect, the wired component is a retractable cord to adjust the length and placement of said electrical component. Other aspects disclosed herein allow the wired component to be modified to allow pendant wired components and/or flush or semi-flush mounted electrical fixtures. For exemplary purposes, and not limitation, the pendant and electrical fixtures could take the form of a chandelier, recessed lighting, a fan, or any fixture as currently utilized in the field, alone or in combination with one another since multiple electrical connections are permissible at the adaptor in a snap-fit configuration. Manufacture of the device may also be modified and designed to accommodate a variety of electrical fixture attachments. As stated above, for example, in one embodiment the wired component is flush with the coverplate.

Aspects herein disclose an electrical component as a light socket that receives an illuminating bulb. As such, the assembly may further comprise a lampshade or design attachment, removably positioned. In one aspect, the design attachment is a stained glass design that allows a full illuminated light or nightlight illumination through stained glass, plastic, or other translucent material. The electrical component may be a stationary attachment for placing any number of electrical components comprising at least one of a light bulb, an outlet, a socket, a plug, a fan, an electrical connection, and audio or visual signal.

Embodiments described herein also disclose a modified electrical box such that the housing is included with the adaptor or adaptor plate, in combination, such that a first snap-install cartridge aligns and affixes at the electrical box mounting location or stud of the construction to align and connect with an interchangeable second snap-install cartridge.

Additional features have been incorporated. For example, at least retractable mechanism may be incorporated for accessing the snap-install cartridge, or the electrical component, alone or in combination, for replacement. Any number of features may be integrated to simplify use and replacement of the electrical fixtures.

A method of using an electrical assembly is described herein, comprising the steps of providing an integrated electrical cartridge having a snap-install housing and at least one adaptor plate, the integrated electrical cartridge having one or more mating features to align and affix the housing at an electrical box, the at least one adaptor plate of which interconnects one or more pre-wired connectors with one or more pre-existing wires of the electrical box; a coverplate to cover the pre-wired connectors; a first electrical component comprising at least one of a socket, a switch, an outlet, a receptacle, a plug, audio or visual component; at least a first wired component having a first end connected through the coverplate to the adaptor and a second end where the electrical component attaches; affixing the integrated electrical cartridge at the electrical box in a fixed configuration; attaching or removing the first wired component in a snap-fit configuration at the adaptor plate; and sliding the coverplate over the adaptor plate. The method of using the electrical assembly further comprises a step of removably placing the first electrical component at the second end of the wired component with a second electrical component in quick-install configuration. In one aspect, the method includes a step of replacing the first wired component with a second wired component that is interchangeable at the adaptor plate in a snap-install configuration. The first wired component attaches to a central connect at the adaptor plate and at least a second wired component attaches to the adaptor plate at a second connect at a periphery of the adaptor plate. In another aspect, a step of attaching or replacing the electrical component at the second end of the wired component includes modifying the design of a lampshade, light bulb socket, or electrical component design by way of a quick-connect adaptor.

Additionally, methods of using the electrical assembly include a step of removably placing adaptable components such as the coverplate, a grommet, a covering or a shade, and any one of a pendant, flush-mount or semi-flush mount electrical connection, alone or in combination at any time individually or simultaneously as integral units. An additional step may include attaching or removing a second wired component having any number of adaptable components.

Various embodiments can be modified in size, shape, dimension, materials utilized, as well as adding automated and/or electronic configurations. In one aspect, an embodiment is an integrated electrical assembly having an installed electrical box with a mating cartridge where an electrician can attach the wires to a female electrical connector. Once the electrical box is professionally installed, any cartridge can be installed by turning and clicking into place. This will both connect the electricity and mount the cartridge. The cover plate can then be screwed into place to cover the cartridge. After snapping in the cartridge and attaching the cover plate, one can pull down the plug and cord with the cord on a retractable cord reel with a locking ratchet, so it can be adjusted to any length. Then the cord can be plugged into the light fixture outlet and screwed together.

In one embodiment, the adaptor with electrical plug-in connections is attached at a standard electrical box. The adaptor has one or more connections to allow more than one electrical fixture to attach. In one aspect, the electrical fixture is a pendant-type fixture ready to interconnect; interconnect; in one aspect, the electrical fixture is a flush-mount slide in fixture such as a speaker or smoke detector or otherwise. As such, the adaptor allows quick-connect features to easily connect one or more fixtures in various configurations.

For exemplary purposes, and not limitation, varying uses and aspects may be employed for use with a ceiling mounted fixture, a chandelier, or a pendant light fixture. Also, the cartridges will come with a variety of cords with different colors, textures and lengths. The cartridges may be utilized for lighting fixtures, electrical decor, electrical outlets and connections, among other such configurations. Such implementations and modifications are apparent by one skilled in the art.

The features of embodiments disclosed herein are distinguished and identified in the following specification. These and other features, aspects, and advantages of the disclosed novelty will become better understood with reference to the following drawings and detailed descriptions.

### BRIEF DESCRIPTION OF THE DRAWINGS

The accompanying drawings, which are incorporated in and constitute a part of this specification, illustrate various embodiments of the present invention, and, together with the description, serve to explain the principles of the invention. The various features are not necessarily drawn to scale. In fact, the dimensions may be arbitrarily increased or decreased for clarity of discussion. In the drawings:

FIG. 1 is a perspective view of an embodiment of the assembly, including FIGS. 1A, 1B, 1C, 1D.

FIG. 2 is another perspective view of an embodiment, including FIGS. 2A, 2B, 2C.

FIG. 3 is a perspective view of one embodiment of the device.

FIG. 4 is a perspective view of a component of the assembly in one embodiment.

FIG. 5 is a perspective view of a component of the assembly in one embodiment.

FIG. 6 is a perspective view of one embodiment.

FIG. 7 includes a top view FIG. 7A, a side view FIG. 7B, and a perspective view FIG. 7C of component in one embodiment of the snap-install assembly.

FIG. 8 is a perspective side view of a component of an assembly.

FIG. 9 is a side view of an electrical connect as a component of the assembly in an embodiment of the invention.

The various embodiments will hereinafter be described in conjunction with the appended drawings.

### DETAILED DESCRIPTION

Reference will now be made in detail to the present embodiments of the invention, examples of which are illustrated in the accompanying drawings. Wherever possible, the same reference numbers will be used throughout the drawings to refer to the same or like parts.

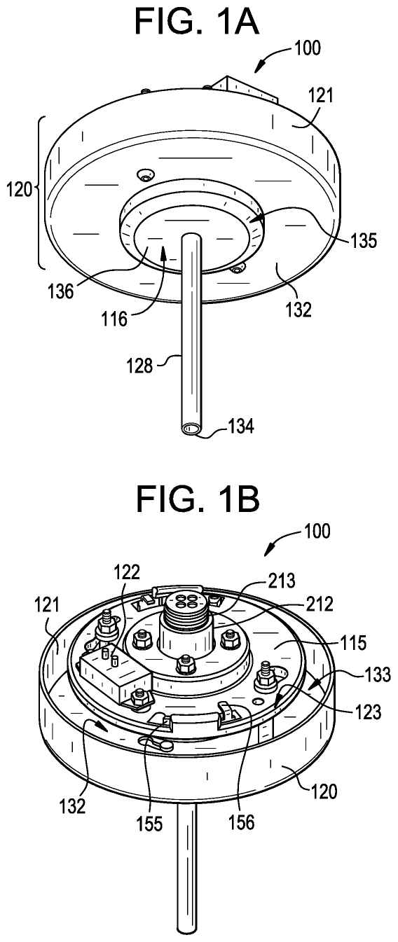

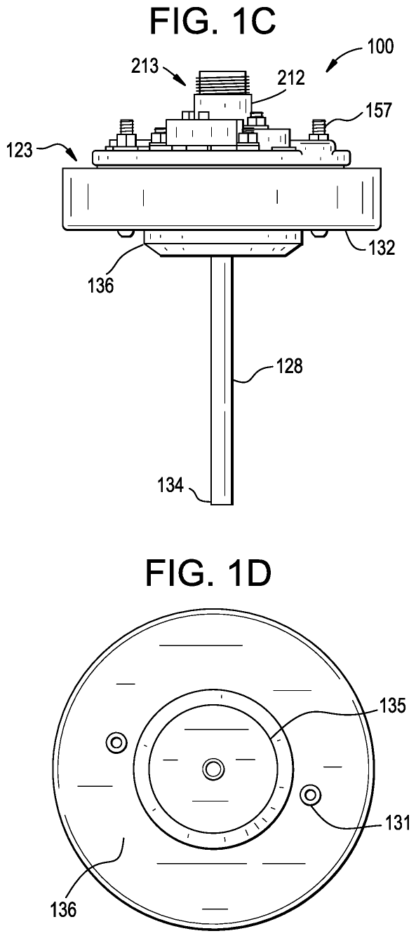

Embodiments of the present invention relate to an easy to install fixture, particularly to an electrical box with a cartridge system directed towards mounting a fixture to a structure and more directly arranged as retractable and an easy to access fixture mounting system. Various embodiments are disclosed herein with reference to the accompanying drawings, in which some embodiments are shown. Indeed, the invention may be embodied in many different forms and should not be construed as limited to the various embodiments set forth herein. The embodiment disclosed at FIG. 1 (including a perspective view at FIG. 1A, a top view at FIG. 1B, a side view at FIG. 1C, and a partial view at FIG. 1D) is an assembly 100 which comprises a cartridge system 120 having a housing 121 with electrical components situated therein such that a cover plate 132 affixes to the housing 121. The housing illustrated at FIG. 1 includes a cylindrical shaped outer surface though any shape housing may be modified and sized to fit the appropriate electrical box. A retractable cord or cable 128 may be coiled inside the housing 121 in the interior space 133 created between the cover plate 132 and the electrical plate 115. The cable 128 has a connector end 134 (e.g. where a plug or light bulb, for example, may attach), that extends through the coverplate 132 at an underside 116 to connect to the hardwired electric at an electric box (the underside of which is shown in FIG. 1B where the cable interfaces with an electrical central adaptor 212); The cable 128 at end 134 connects to an electrical fixture (e.g. the plug or light bulb socket). The cable 128 slides through a grommet 136 that attaches at the underside of the cartridge system 120 at the coverplate 132. At a top perspective view of the cartridge system in FIG. 1B, an adaptor 212 interconnects with the wiring of an installed and mounted electrical box (not shown here). The adaptor 212 here is a snap-in mating component where electrical connections converge to mate with the wiring at the electrical box. Threads 213 are illustrated to further secure the electrical interconnection. The adaptor plate 115, or electrical plate 115 has a surface 123 that is a structural mounting surface that attaches to the housing 121 at a top side near the electrical inner connections to close the cartridge system 120 and prevent any external environmental components (i.e., water, dust, debris) from entering the cartridge once the cartridge is installed at the electrical box.

At FIG. 1B, the interior space comprises electrical hardwire components 122. The electrical wires 122 are electrically connected/hardwired to electricity at the mounting surface of an electrical box, or receiving structure. In one aspect, the interior space houses a female electrical connector. The female electrical connector is capable of interconnecting with a male electrical connector counterpart housed at the electrical box, or modified second cartridge assembly. Adaptor parts of male and female connectors, however, are interchangeable and situated vice versa.

Apertures 155 and mounting electrical connects 156 are constructed to attach to interconnect the cartridge at a secondary connection point on a mounting surface of the electrical box by way of a sliding mechanism to insert the tab and twist to secure. At FIG. 1C, screws 157 or any other attachments as known in the art may be utilized to secure the unit to the electrical box at a wall or ceiling. . At FIG. 1D, the grommet 136 secures the cable in place in a stable configuration. The grommet includes a raised edge 135 that may be further secured to the cartridge 120 by snap-fit quick-connect features 131. Such quick-connect features include snap-install mating mounts, insert and twist tabs, quick-screw and quick-release snap on mechanisms.

As shown here, a cartridge assembly is placed with an existing electrical box, recessed or extending from the surface intended for mounting of the light fixture. In another aspect, a first cartridge assembly may be recessed into a mounting surface of a building wall, such that that mounting fixtures attach to a frame or stud during construction. Snap-in attachments attach to a surface of a second cartridge assembly. In another aspect, the snap-in attachments align with the second cartridge assembly that is a flush mounted light fixture, a cartridge holding additional electrical wire for a hanging a light fixture, a smoke detector, or an artificial intelligent device such as a voice recognition device or remote control smart device, or any other attachment as would be utilized by one skilled in the art. Such designs may be implemented and modified so as not to distract from the unity of invention. Any variations of connections and interconnection may be modified to accommodate the current utility of the embodiment described.

In one aspect, the connector end 134 connects to a light fixture; in another aspect, an outlet is connected, or any electrical component that operates by way of connection to an electrical source. The cartridge may be comprised of metal, plastic, wood, or a combination of materials as may be regulated in the electrical industry. The housing is attached to the interior or exterior of a wall or structure to provide lighting or a source of electricity at a designated site. As well, the screws or other mechanical attachments or mounts may take the form of any attachment known in the art that would secure physical components together. As well, the attachments may be mating features to interlock or connect with one another in a mating fashion.

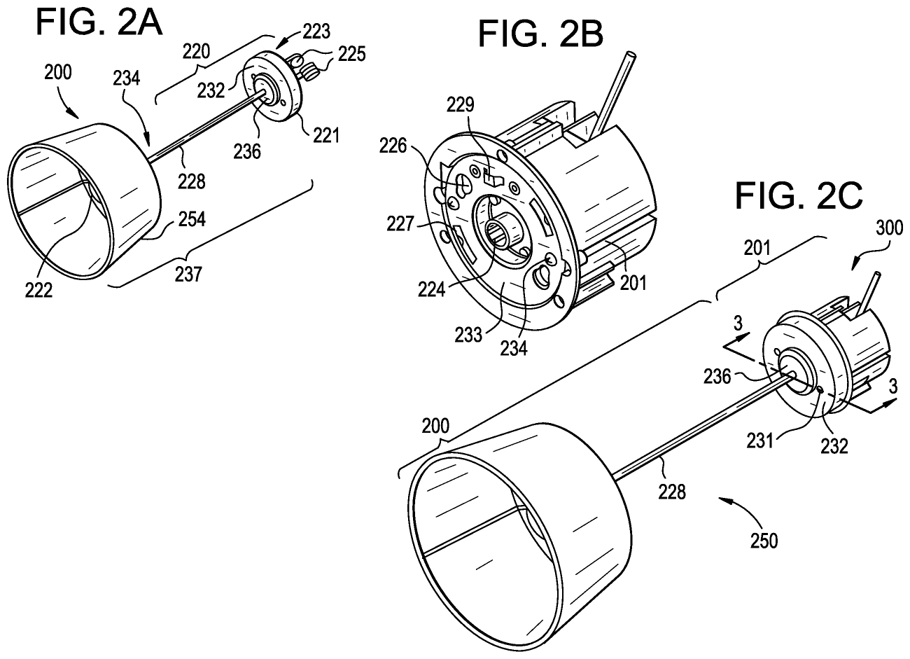

As depicted in FIG. 2, an assembly 200 at FIG. 2A is attached to an electrical box 201 of FIG. 2B, and integrated into an integral electrical configuration 250 at FIG. 2C. At FIG. 2A, a perspective view of an assembly 200 includes a cartridge system 221 with a light socket 222 having a pendant shade 254 secured at an end 234 of a cable 228. The cartridge system 220 is configured to attach to an electrical box 201 such as that depicted in FIG. 2B. The pre-crimped connectors 225 (i.e., connecting the wires at the cartridge system) are integrated into an adaptor (e.g. such as 212 of FIG. 1) and slide into an electrical mount at a mated opposing part 224 of the electrical box b. Thus, the adaptor connect and cartridge assembly 220 snap into place with the electrical box 201 to form an operational electrical assembly 250.

As shown in FIG. 2A, the structural mounting surface 223 of the housing 221 is a partial surface comprising mounting brackets to engage with the twist and lock mating apertures 226 226 and apertures in combination with electrical connections 227 at adaptor plate , and the mounting surface b also having a second electrical connecting central adaptor (not illustrated here but central to connectors 225) that aligns and connects at mated electrical connection 224. The mounting brackets and mating apertures, in combination, allow for snap-in attachment to any electrical box.

As demonstrated by FIG. 2, at a first step, a light bulb holder 222 (e.g. socket) is positioned at the end 234 of the fixed cable 228 such that the cable, here about eight to twelve inches in length, is slid into the middle hole of a faceplate of a pendant shade 254. The grommet 236 that is positioned on the cable 228 is then twisted and locked into the adaptor and covered by the coverplate 232. For clarification, the socket 222 with pendant shade 254 connected with the cable 228 and grommet 236 form the snap-install socket pendant unit 237. Prior to quick-connect of the snap-install pendant unit 237, however, a first cartridge is placed at the electrical box. Here, an adaptor plate 233 is placed using screws 234 to mount the snap-install adaptor to the electrical box. Once placed, the snap-install adaptor has snall-install units, such as the snap-install socket pendant unit 237 that are interchangeable by a quick-attach and quick-detach of the snap-fit mechanism and allowing a user to interchange a pendant unit with a flush or semi-flush snap-install unit, or vice versa, as desired. The connectors 225 are utilized to hard-wire the adaptor plate 233 into place, the adaptor plate having a mating adaptor 224 at the electrical box 201 to interchange the snap-install units and/or pendant units 237. A slide-in aperture 227 is configured on the adaptor plate to integrate secondary electrical connections. Where the cartridge is a slide-in electrical mount utilizing an adaptor, the switch 229 is positioned to the “I” position to receive the electrical input. To make operational, the structural mounting surface 223 is aligned, twisted and locked into the adaptor 224 at adaptor plate 233. A light bulb can then be inserted into the socket 222. As demonstrated here, any of easy slip lampshades may be affixed and secured.

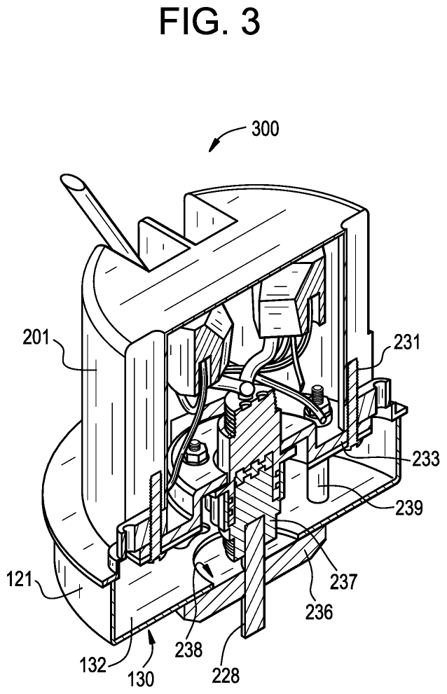

FIG. 3 is a perspective side view of the assembly 300. Here, the interior of the cartridge 220 illustrates the housing 121 as a circular perimeter wall with a base end 130. In one embodiment, the base end 130 of coverplate 132 is a flat surface though any structural surface can be accommodated by the assembly whereby the base end may be flat, wavy, curved, or as desired. For exemplary purposes, and not limitation, the surface to which the assembly can attach may have a concave curvature, and so the base end 130 may take a convex shape, or vice versa. Such designs may be implemented and modified so as not to distract from the unity of invention. In this respect, the base end 130 may not fully enclose the housing 121 at one end, and instead provide a partial surface to attach a retractable electrical reel. Screws 231 attach the adaptor plate 233 as a first installed fixed cartridge to the electrical box 201. Here, the electrical box is a standard electrical box. Other configurations may include custom designed snap-install features for convenient snap-in installation of light fixtures, sockets, plugs, switches, or other electrical outlet, plug, or receptacle. The twist post 239 twists into the base end 130 of coverplate 132. The snap-install socket pendant unit 237 slides through the middle hole 238 of the coverplate 132 to align and affix the housing 121 to the electrical box. The coverplate may also be a design configuration modified by the user as desired. Here, the grommet 236 covers any hole or gaps to aesthetically and functionally secure the cable 228.

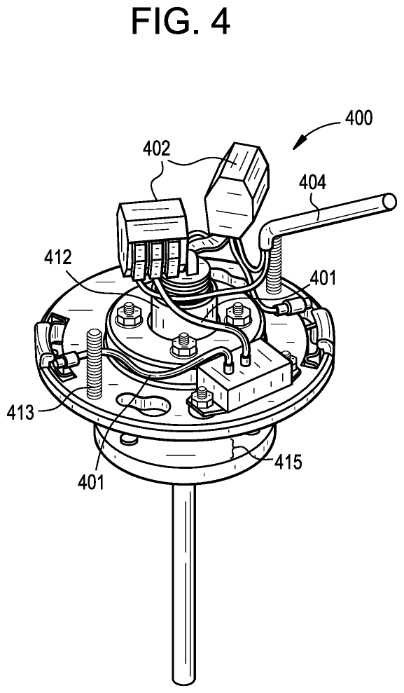

FIG. 4 depicts a snap-install assembly 400 of cartridge system 120 from FIG. 1 such that wires 401 are pre-wired to a hard-wired direct connect 404 and integrated at connectors 402 with an adaptor 412. The connectors here are wirenuts, wago nuts, or other push-wire connector for solid and standard copper wire. Any connector, including taped connections may integrate with the electrical connections to facilitate the quick install snap-install configuration. The intent of the assembly with quick adaptations is to more easily and efficiently allow the interchanging of light fixtures for functionality and/or design. The screws 413 get tightened into the electrical box to further secure the snap-install assembly as an integral electrical fixture.

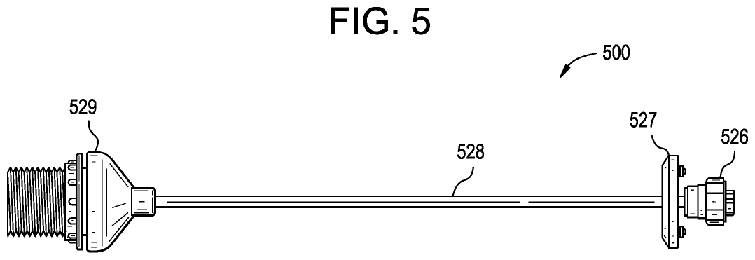

One embodiment of a snap-install assembly 500 is illustrated as a pendant connector 500 at FIG. 5. As shown, the pendant connector includes a cable 528 as a fixed length cable. The pendant may have any length, even less than one inch such that the snap-install assembly is semi-flush with the adaptor assembly. Here, the length of the cable is about 18 inches, and 12-24 inches for a chandelier-type fixture; though, any length cable including a fixed or retractable cable may be implemented, from minimal dimensions less than a ½ inch to ½ inch to 12″ or more. At a first end of the cable 528, a pendant connector 526 interconnects with the adaptor connect at an electrical box; at the opposing second end is a lamp holder 529. Here, the lamp holder 529 is a light socket that accepts a screw-in light bulb. A shade can be integrate at the lamp holder as well. The grommet 527 is a support that affixes to the housing of an electrical box (that is fixed to a structure) or to the coverplate to secure the cable 528 in a stable configuration, as desired.

In one aspect, the fixed cable 128 is a retractable cord 128 that may include a cloth or plastic covered wire that pulls out from a retractable reel inside the cartridge. For exemplary purposes only, and not limitation, the retractable reel may be housed on an underside of the cartridge such that a space is created between the grommet and the coverplate and is completely surrounded by the housing. Looking at FIG. 4, the space for the retractable reel and cable may be positioned at space 415. A locking mechanism may lock the cord in place and/or prevent retraction of the cord while engaging the electrical connection or socket of the connector end 234 as shown in FIG. 2. Variations of the reel allow designs that are mechanical or electrical, and preferably controlled by mobile application (i.e. app) or other remote controlled digital features and controls.

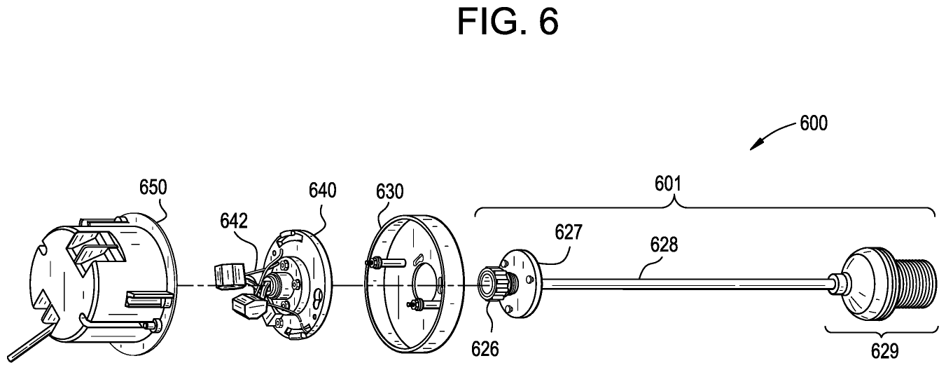

As shown in FIG. 6, an assembly 600 is depicted as blown-up sectional parts and components. The assembly 600 comprises a pendant connector 601 including cable 628, with a connector 626 at a first end that protrudes through the grommet 627 and connects to the adaptor 640 through the coverplate 630. A lamp holder with socket 629 at a second end of the cable 628 accepts a screw-in light bulb. The adaptor in combination with the coverplate and pendant connector incorporate with the electrical wiring at a ceiling electrical box 650 in a snap-install configuration. For clarification, the electrical wires at the electrical box 650 are connected to the snap-install adaptor 640 at electrical wire connectors 642 and then screwed into place. Once electrical wiring is attached, any snap-install adaptor can be attached without tools by snapping and turning into place. The snap-install coverplate 630 installs by snapping and turning into place with the snap-install adaptor 640. As such the coverplate can be designed as desired by a user. The snap-install pendant connector 601 is a snap-install socket pendant 601 that is installed by pressing the connector into place and snapping and turning the grommet in place. A lampshade can be slid over the socket before or after installation. In one aspect, the snap-install components of the adaptor, coverplate and pendant connector are an integral unit as shown here and indicated at FIG. 1 as well. In another aspect, the parts may be organized and arranged to snap-fit with one another in an efficient and individual assembly of parts. The invention disclosed has advantages that allows electrical wiring to be connected to the connector components of an adaptor. Thereafter, any snap-install adaptor and/or assembly or components may be interchangeable without the use of tools or an electrician. Any user may modify the light fixture to a switch, outlet, socket, plug, or other electrical connection point. As well, the lighting or electrical fixtures may be extended from an electrical box at a structural surface or recessed into a structural surface or wall.

The connection is made possible for anyone capable of changing a light-bulb or capable of plugging a plug into an outlet. Snap-in female electrical connector parts and male electrical connector parts simplify connection of electrical components for household residential and commercial use. Snap-in components, tabs, and apertures, including, complementary attachments may be further adapted and arranged to aid easy install and maintenance.

In one aspect, the first cartridge is a snap-install electrical box that mounts on the ceiling and has female connector and interconnection (for both the electrical component and the snap-in attachment, respectively); in such case, the connecting second cartridge would have a male electrical component and male interconnecting snap-in component, respectively. The female and male electrical connections, as well as interconnecting housing components may be mixed interchangeably in any variation or design to accommodate ease-of-use.

In one embodiment, a first cartridge assembly 600 can be constructed to replace any existing electrical boxes as utilized for standard residential or commercial use. In one aspect, the first cartridge is mounted, electrically connected and hardwired to the desired structure (typically by a certified electrician). Once the cartridge 600 is mounted and electrically connected, any person may be capable of interconnecting a second cartridge adaptable to the first. As well, once the cartridge 600 is mounted and electrically connected, any component part may be easily removed and detached in an easy-release or by a reverse snap or twist mechanism. Therefore, a user can easily change light fixtures for common lighting and architectural purposes, change the lighting fixtures to accommodate interior and exterior designs, or any variations thereof.

The cartridge assemblies as defined herein may vary in size, shape, and configuration as dependent on architectural design and use in residence or commercial settings. The cartridge(s) provide a snap-in mechanical configuration for direct attachment to the structure, and also a snap-in electrical connection that is easy to use, change, and interconnect, as desired.

Embodiments of the assembly disclosed herein may also integrate a second cartridge that is may be slightly smaller in overall shape so as to fit within the first cartridge, or vice versa.

In one embodiment, a safety feature does not allow electricity to flow until the electrical components are not capable of being reached or altered, such as when a locking mechanism interconnects the first and second cartridges to form the cartridge assembly.

Attachment pieces and/or snap-install features herein disclosed create a manner of securing the snap-install assembly at the electrical box or hardwired electrical wiring. In one embodiment the attachment pieces are engaged by placing the a snap-install feature of one component into a secondary surface of a second component, and then turning, then snapping attachment pieces into place to secure the assembly.

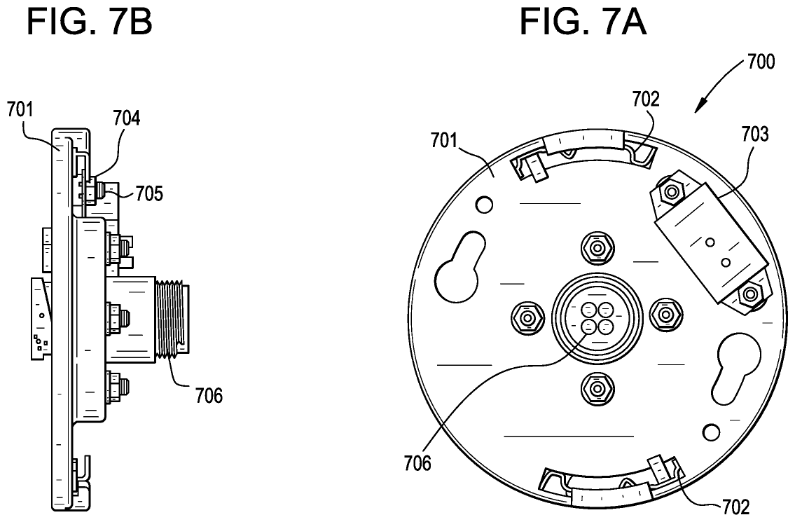

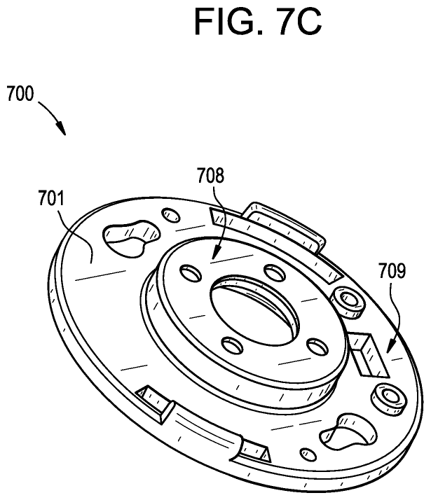

FIG. 7 illustrates a top view (FIG. 7A) and a side view (FIG. 7B) of the snap-install adaptor assembly 700. Within the adaptor plate 701 are two slide connectors 702 characteristic of the snap-install features to create and insert and twist snap-fit, and including secondary electrical connections, such as for a smoke detector or other slide-in flush fixture. The slide connectors interface with a secondary electrical connections to allow any number of electrical fixtures to attach. In one aspect, a smoke detector may attach at this adaptor plate, alone or in combination with a light fixture (or other fixture) that interconnects at the central adaptor connector 706. Any detector or sensor may be placed, for example, such as for biological detection, chemical or nuclear sensing, or as needed. As such, an electrical circuit is created at connections 702 such that electricity follows from the positive pole (terminal) to the negative pole. The connections 702 can be indicated as +/− for clarification.

A switch 703 provides an on-off control of electricity into and out of the assembly, disconnecting and connecting the conducting path in the electrical circuit, interrupting the electric current of diverting it from one conductor to another. A nut 704 and fastener 705 secure the component parts of the adaptor assembly. An adaptor connector 706 allows any number of adaptor plates to be attached and detached as a quick-attach and quick-release mechanism. FIG. 7C includes a perspective view of the adaptor plate 701 having a raised secondary surface 708 distinct from a first surface 709 so that parts and components can be accommodated with the install with a coverplate at the electrical box.

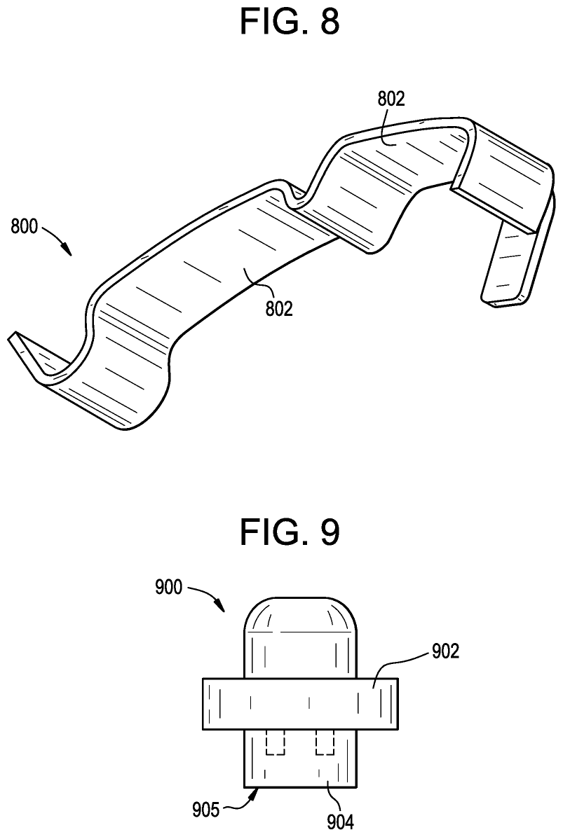

At FIG. 8, a slide-in connector 800 is depicted that would easily house the adaptor assembly at hard-wired electrical connections of a structure, alone or in combination with an electrical box. The elevated surfaces 802 of the slide-in connector are adjusted and manufactured to house a specified adaptor, configured having mating structural walls and surfaces for easy slide-in quick connection.

While various configurations of the electrical connections are possible, an easy connect plug and outlet connection may be the mating features integrated with a snap-install assembly. Thus, instead of a fixed cord or cable assembly with a pendant, the cable may be a retractable cord with a plug attached. Such plug would interconnect at an adaptor plate assembly that houses an outlet at the electrical box; or the plug may be a provision at the secondary end of the cord where the socket was placed such that the socket or other electrical connector would be interchangeable by way of a plug interconnect as shown in FIG. 9. As depicted, a plug interconnect 900 comprises a male mating electrical connect 902 interconnected with the female mating electrical connect 904. An external surface 905 of a female mating electrical connect would be integrated with the hardwired components in this illustration. In another embodiment, the external surface 905 would be incorporated at the end of the pendant as illustrated in FIG. 5, but with the plug interconnect in place of the socket for easy install and detachment. As well, the female connect, or outlet component 904 may comprise a designer connector such as an LED included therein.

As demonstrated, the electrical fixture here illustrated as a light fixture can be inverted to be a recessed fixture, or converted to any number of electrical switches, plugs, lights, sockets, or electrical adaptors. The snap-install fixture can be integrated into the wall or ceiling-mounted electrical box, pendant fixture, flush-mount or semi-flush mount, as would be, for example (and not limitation), a light switch that is flush with a wall, or a speaker that that would be semi-flush. Other electrical components can be integrated to include any number or electrical units as known in the art, to include, without limitation, a speaker such that the external audio surface interfaces with the external environment, a fan, chandelier, or otherwise. As well, the assembly can be a smoke detector cartridge replacement such that the electrical connection in combination with mounting brackets interconnect at the electrical box for quick easy-installation and replacement of electrical component parts. Such a mounting bracket 800 as shown in FIG. 8 is adaptable to hold the smoke detector. The slide-in mount 800 is characteristic for use with a slide-in cartridge such as the smoke detector or other lighting fixture mounted in a flush-mount configuration at the electrical box and adaptor.

Such variations are included herein as would be known in the art so as to easily replace any and all electrical assemblies with the interconnected cartridge components that configure an electrical assembly disclosed.

Various aspects of the cartridge assembly utilize materials and compositions such as metal, thermo-molded plastics, high temperature resistant components, and any other material as commonly used in the art. The assembly may integrate dividers constructed using similar materials as well. As such, the assembly may divide the interior space of the cartridge into a plurality of sections to segregate components housed therein.

The embodiments of the invention described herein are exemplary and numerous modifications, variations, and rearrangements can be readily envisioned to achieve substantially equivalent results, all of which are intended to be embraced within the spirit and scope of the invention. Further, the disclosure herein enables one of skill in the art to practice and modify the embodiments disclosed without departing from the scope and essence of the disclosed device, system, and method of use.

What is claimed is:

1. An electrical snap-install cartridge comprising:
an adaptor removably placed with an electrical box, the adaptor having pre-wired connectors attached to one or more pre-existing wires in the electrical box; and
at least one interchangeable electrical unit having at least one electrical interconnection at a first end that extends to a second electrical connection at a second end, the first interconnection of which connects to the adaptor;
wherein the interchangeable electrical unit comprises mated components that quick-connect to and from the adaptor.

2. The electrical snap-install cartridge of claim 1, further comprising a coverplate assembly which aligns to cover the adaptor.

3. The electrical snap-install cartridge of claim 2, further comprising a grommet that secures the electrical unit through the coverplate to the adaptor.

4. The electrical snap-install cartridge of claim 3, wherein any one of the interchangeable electrical units is replaceable with an adaptable electrical component or electrical fixture.

5. The electrical snap-install cartridge of claim 4, wherein the interchangeable electrical unit is covered by a covering including a lamp shade, transparent or translucent glass, or three-dimensional design covering.

6. The electrical snap-install cartridge of claim 5, wherein the interchangeable electrical unit, the coverplate assembly, the grommet, or the covering are adapted for easy assembly and dis-assembly in a snap-install configuration, alone or in combination.

7. The electrical snap-install cartridge of claim 1, wherein the electrical unit is a socket, a switch, an outlet, a receptacle, a sensor or a detector, a plug, a speaker or any electrical component, in pendant or flush-mount configurations.

8. The electrical snap-install cartridge of claim 1, wherein the electrical cable is adjustable and capable of being fixed to accommodate the size and dimensions of the electrical unit.

9. An electrical assembly comprising:
a cartridge having an adaptor to interconnect one or more pre-wired connectors with one or more pre-existing wires in an electrical box, the adaptor comprising one or more interconnecting electrical connections, and the cartridge having an engagement mechanism to mount to the electrical box;
a coverplate assembly securing a surface that covers the pre-wired connectors; and
at least one wired component having a first end connected through the coverplate to the adaptor and a second end connected to an electrical component,
wherein said wired component is interchangeable in a snap-fit configuration.

10. The electrical assembly of claim 9, wherein the one or more interconnecting electrical connections connect to a plurality of wired components.

11. The electrical assembly of claim 10, wherein the interconnecting electrical connections are positioned at a central location on an adaptor plate, in a middle region, or along a periphery of the adaptor plate.

12. The electrical assembly of claim 9, wherein said electrical component is interchangeable in a snap-fit configuration.

13. The electrical assembly of claim 9, further comprising one or more electrical interconnections at the second end of the wired component to allow a user to modify the electrical component.

14. The electrical assembly of claim 9, wherein the wired component is a retractable cord to adjust the length and placement of said electrical component.

15. The electrical assembly of claim 9, wherein the wired component is flush with the coverplate.

16. The electrical assembly of claim 9, wherein the electrical component is a light socket that receives an illuminating bulb.

17. The electrical assembly of claim 9, further comprising a lampshade, removably positioned.

18. The electrical assembly of claim 9, wherein the electrical component is a stationary attachment for placing any number of electrical components comprising at least one of a light bulb, an outlet, a socket, a plug, a switch, a receptacle, a sensor, a detector, a speaker, a fan, an electrical connection, and audio or visual signal.

19. The electrical assembly of claim 9, wherein the cartridge with the adaptor, in combination, is a first snap-install cartridge that aligns and affixes at the electrical box to align and connect with an interchangeable second snap-install cartridge.

20. The electrical assembly of claim 9, further comprising at least one retractable mechanism for accessing the snap-install cartridge, or the electrical component, alone or in combination, for replacement.

21. A method of using an electrical assembly, comprising the steps of:
providing an integrated electrical cartridge having a snap-install housing and at least one adaptor plate, the integrated electrical cartridge having one or more mating features to align and affix the housing at an electrical box, the at least one adaptor plate of which interconnects one or more pre-wired connectors with one or more pre-existing wires of the electrical box; a first electrical component comprising at least one of a socket, a switch, a receptacle, a fan, an outlet, a plug, audio or visual component; at least a first wired component having a first end connected through the coverplate to the adaptor and a second end where the electrical component attaches;
affixing the integrated electrical cartridge at the electrical box in a fixed configuration; and
attaching or removing the first wired component in a snap-fit configuration at the adaptor plate;

22. The method of using the electrical assembly of claim 21, further comprising a step of affixing the coverplate over the adaptor.

23. The method of claim 21, further comprising a step of removably placing the first electrical component at the second end of the wired component with a second electrical component in quick-install configuration.

24. The method of using the electrical assembly of claim 21, further comprising a step of replacing the first wired component with a second wired component that is interchangeable at the adaptor plate in a snap-install configuration.

25. The method of using the electrical assembly of claim 21, wherein the first wired component attaches to a central connect at the adaptor plate and at least a second wired component attaches to the adaptor plate at a second connect at a second location on the adaptor plate.

26. The method of using the electrical assembly of claim 21, wherein the step of attaching or replacing the electrical component at the second end of the wired component includes modifying the design of a lampshade, light bulb socket, or electrical component design by way of a quick-connect adaptor.

27. The method of using the electrical assembly of claim 21, wherein the step of attaching or removing the first wired component comprises removably placing adaptable components including a coverplate, a grommet, a covering or a shade, and any one or a pendant, flush, or semi-flush mount electrical connection, alone or in combination at any time.

28. The method of using the electrical assembly of claim 27, further comprising a step of attaching or removing a second wired component having any number of adaptable components.
